(19) United States
(12) Patent Application Publication
(10) Pub. No.: US 2017/0356612 A1
(43) Pub. Date: Dec. 14, 2017

(54) ANTI-GLARE SYSTEM FOR VEHICLES

(71) Applicant: Edgar Hosiel Leon Esquivel, Storm Lake, IA (US)

(72) Inventor: Edgar Hosiel Leon Esquivel, Storm Lake, IA (US)

(21) Appl. No.: 15/399,510

(22) Filed: Jan. 5, 2017

(30) Foreign Application Priority Data
Jun. 13, 2016 (MX) MX/U/2016/000242

(51) Int. Cl. F21S 8/10; B60J 3/06; B60Q 1/14; F21V 9/14; B60R 1/08; G02B 1/11; B60J 1/02

(52) U.S. Cl. CPC F21S 48/114; B60R 1/083; B60J 3/06; G02B 1/11; B60Q 1/14; F21V 9/14; B60J 1/02

(57) ABSTRACT

An anti-glare system for vehicles has a linear polarized filter mounted to a headlight of a vehicle with the positive side of the filter placed at a 135 degree angle relative to a horizontal line. A second linear polarized filter is mounted to a windshield of the vehicle with the negative side of the second filter placed at an angle of 45 degrees relative to a horizontal line. When vehicles equipped with this anti-glare system meet travelling in opposite directions, the polarized light emitted by the headlight of one vehicle is blocked by the filter installed in the windshield of the other vehicle. A third linear polarized filter may be mounted to rear and side view mirrors of the vehicle with the positive side of the third filter placed at an angle of 135 degrees relative to a horizontal line. When vehicles equipped with the anti-glare system meet travelling in the same direction, the polarized light emitted by the headlight of one vehicle is blocked by the filter installed in the rear or side view mirror of the other vehicle.

### CROSS-REFERENCE TO RELATED APPLICATIONS

This application claims priority to Mexican Patent Application No. MX/u/2016/000242, filed on Jun. 13, 2016, the entirety of which is hereby incorporated herein by reference.

### BACKGROUND

In the present time, driving at night is dangerous because on the roads drivers encounter other vehicles driving in the opposite direction and/or from behind, causing visibility to be practically null or blind for a few moments. Because the intense light produced by other cars can limit a driver's ability to see what is in front of the vehicle on the road, accidents can occur, causing serious injuries or even death.

To correct this problem, an anti-glare system is disclosed, with the purpose of preventing accidents caused by frequent periods of intense light encountered by driving at night.

### BRIEF DESCRIPTION OF THE FIGURES

FIG. 1 illustrates an exploded view of vehicle headlights of an anti-glare system for vehicles.

FIG. 2 illustrates vehicle headlights of an anti-glare system for vehicles.

FIG. 3 illustrates a rear view mirror of an anti-glare system for vehicles.

FIG. 4 illustrates a side view mirror of an anti-glare system for vehicles.

FIG. 5 illustrates a windshield configuration of an anti-glare system for vehicles.

FIG. 6 illustrates an example of the operation of an anti-glare system for vehicles.

### DETAILED DESCRIPTION

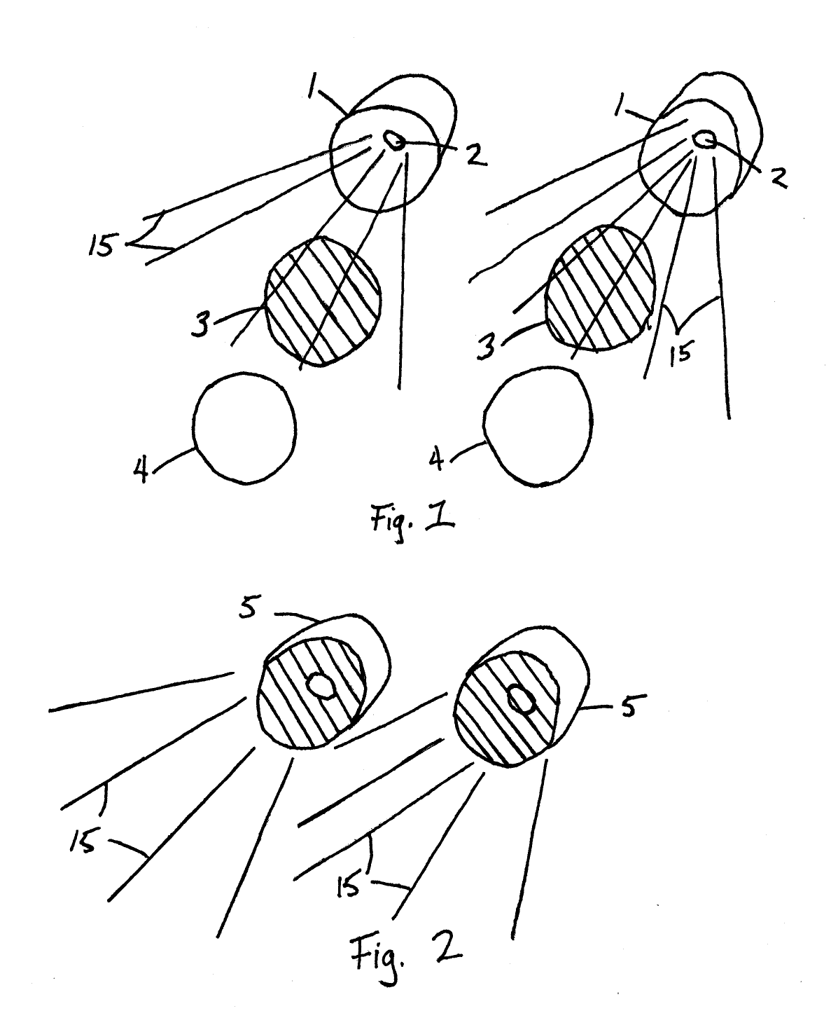

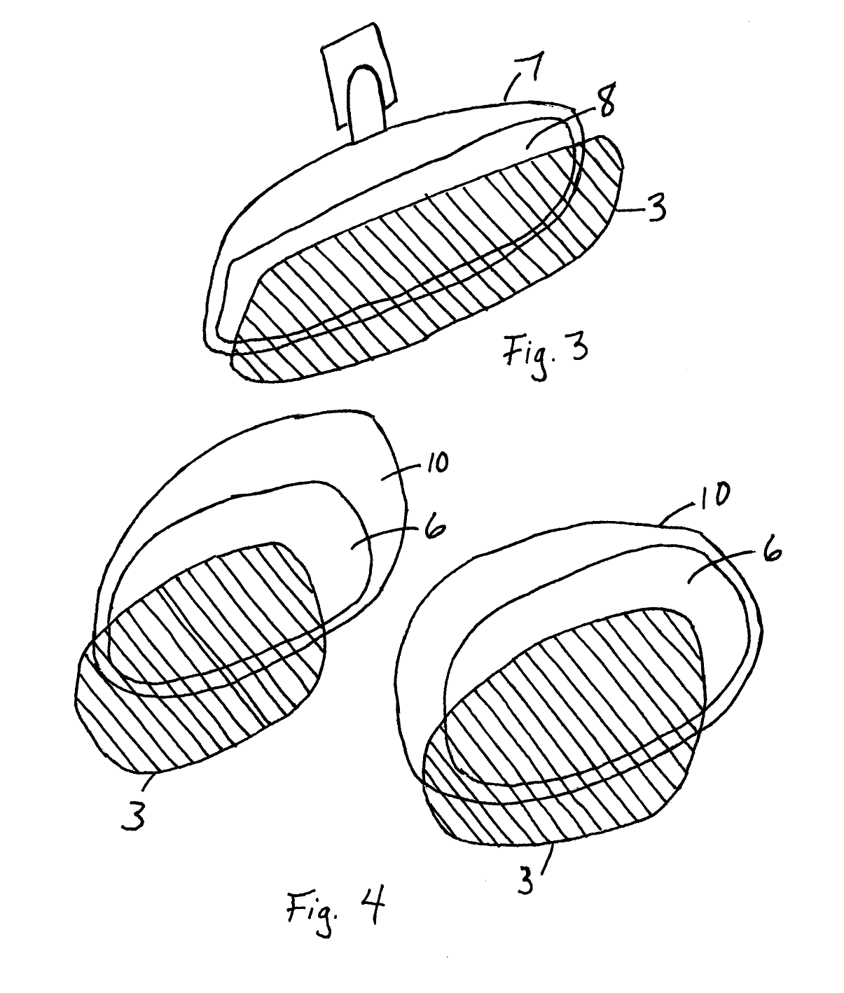

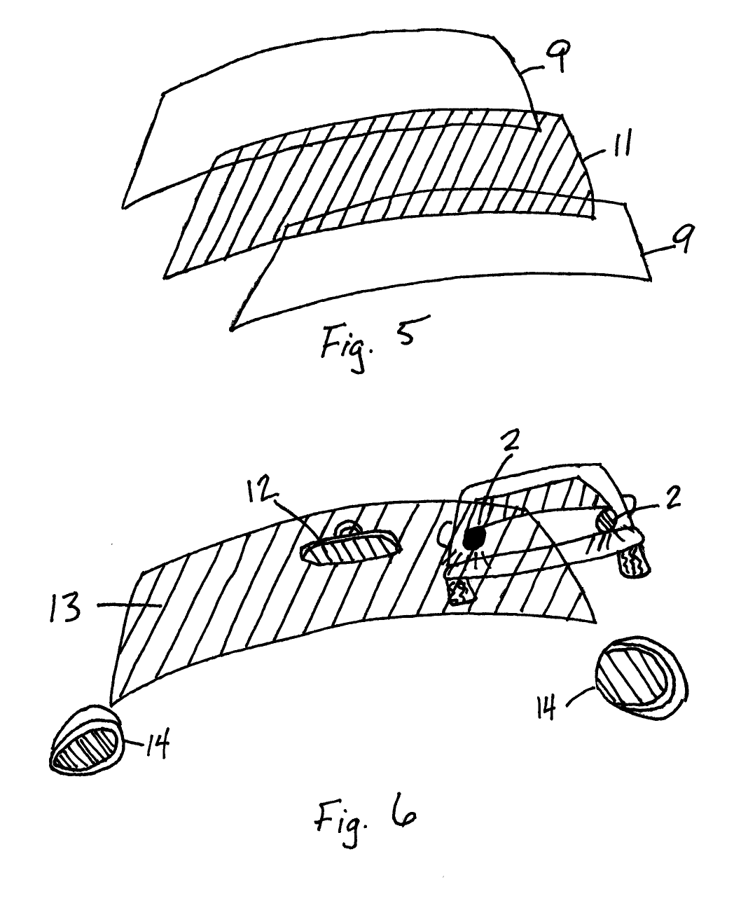

Referring to FIGS. 1-6, an anti-glare system for vehicles comprises the following components:

Reference number 1 refers to an LED focus casing;
Reference number 2 refers to an LED light;
Reference number 3 refers to a linear polarized filter placed with the positive side at an angle of 135 degrees relative to a horizontal line on the right side;
Reference number 4 refers to a transparent crystal;
Reference number 5 refers to the assembly of LED focus casing 1, LED spotlight 2, linear polarized filter 3, and transparent crystal 4;
Reference number 6 refers to a side-view mirror;
Reference number 7 refers to the casing of central rear view mirror 8;
Reference number 8 refers to a central rear view mirror;
Reference number 9 refers to an automotive windshield;
Reference number 10 refers to the casing of side view mirror 6;
Reference number 11 refers to a linear polarized filter placed with the negative side at a 45 degree angle relative to a horizontal line on the right side;
Reference number 12 refers to the assembly of casing 7, central rear view mirror 8, and linear polarized filter 3;
Reference number 13 refers to the assembly of windshield 9 and linear polarized filter 11;
Reference number 14 refers to the assembly of casing 10, side view mirror 6, and linear polarized filter 3.

The anti-glare system for private, commercial, or other automotive vehicles to which the invention relates is composed of linear polarized filters (3) and (11), LED lights (2), mirrors (6) and (8), windshields (9), and transparent crystals (4). Using a light casing (1) a linear polarized filter (3) is placed with the positive side at an angle of 135 degrees relative to a horizontal line on the right side between the LED light (2) and the transparent glass (4). This combination must be installed in all vehicles as it is the source of the already emitting LED light. A linear polarized filter with negative side at 45 degrees relative to a horizontal line on the right side (11) must be installed between the windshields (9) of the subject vehicle and the windshield (9) of an oncoming vehicle in order to neutralize the light source of the LED light (2) of the oncoming vehicle, allowing the driver of the subject vehicle to be able to see farther without being blinded. A linear polarized filter (3) is placed in the side mirrors (6) and in the central rear view mirror (8) with positive side at an angle of 135 degrees relative to a horizontal line on the right side to neutralize the light source of the LED light (2) of an emitting vehicle traveling in the rear and in the same direction as the subject vehicle without blinding the driver.

FIG. 6 illustrates how the anti-glare system blocks light from an oncoming vehicle from the perspective of a subject vehicle. As shown, the light of one of the headlights (2) on the left side of the oncoming vehicle is blocked and looks as if it took a black color as a function of the linear polarized filters (3) and (11) placed correctly in the lights (2), windshields (9) and mirrors (6) and (8).

1. An anti-glare system for vehicles for preventing temporary blinding of drivers by the light of approaching vehicles comprising:
a headlight mounted to a first vehicle;
a first linear polarized filter mounted to the headlight, wherein the first linear polarized filter has a positive side and a negative side, and wherein the positive side of the first linear polarized filter is placed at an angle of 135 degrees relative to a horizontal line; and
a second linear polarized filter mounted to a windshield of a second vehicle, wherein the second linear polarized filter has a positive side and a negative side, and wherein the negative side of the second linear polarized filter is placed at an angle of 45 degrees relative to a horizontal line;
wherein light emitted by the headlight is polarized by the first linear polarized filter, and the second linear polarized filter is configured to block the polarized light emitted by the headlight.

2. The anti-glare system of claim 1 further comprising a third linear polarized filter mounted to a rear-view mirror of the second vehicle, wherein the third linear polarized filter has a positive side and a negative side, and wherein the positive side of the third linear polarized filter is placed at an angle of 135 degrees relative to a horizontal line; wherein the third linear polarized filter is configured to block the polarized light emitted by the headlight.
